(19) United States
(12) Patent Application Publication
(10) Pub. No.: US 2003/0044586 A1
(43) Pub. Date: Mar. 6, 2003

(54) Ink-jet recording material

(75) Inventors: Takahiko Nojima, Tokyo (JP); Keiji Ohbayashi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/165,626

(22) Filed: Jun. 7, 2002

(30) Foreign Application Priority Data
Jun. 15, 2001 (JP) 181542/2001

(51) Int. Cl. B41M 5/00

(52) U.S. Cl. 428/195

(57) ABSTRACT

An ink-jet recording material comprising a support having thereon a first layer and an ink-receiving layer in that order, wherein the first layer comprising a resin polymerized by emulsion polymerization in the presence of a polymer dispersant having at least a hydroxyl group; and the ink-receiving layer comprising water-soluble binder and inorganic particles having an average particle diameter of 3 to 200 nm.

### FIELD OF THE INVENTION

The invention relates to an ink-jet recording material.

### BACKGROUND OF THE INVENTION

In the ink-jet recording, very fine droplets are filed by various function principles and adhered onto a recording sheet to record an image or character. This method has advantages such as a relatively high speed, low noise and easy applicability for multi-color recording. There are problems in this method such as blocking of the nozzle and difficulty of maintenance of the apparatus. These problems are solved by improvements both of the apparatus and the ink. Consequently, the ink-jet recording method is rapidly spread in various fields such as that of printer, facsimile and computer terminal.

It is generally required to the recording material to be used for the ink-jet recording that the density of dot is high, the color tone is clear and bright, the absorption of ink is rapid and the ink is not flowed out and not spread, the diffusion of the printed dot in the lateral direction is not larger than needed and the edge of the dot is smooth and not blurred.

Many trials have been performed to make near the image quality obtained by the color ink-jet recording to that of a photograph. The most important substance for raising the dot image quality is to make the individual dots to indistinguishable. For such the purpose, it is important to make the ink droplet to further fine, and to use of an ink with a low dye concentration together with an ink with the standard dye concentration for lowering the distinguishing ability of the individual dot by reducing the reflective density of the dot in the high light portion of the image.

Accordingly, the jetted amount of the ink tends to be increased so that the degradation of the quality and the drying ability of the printed image are appeared, which are caused by flowing out of the ink as a result of the insufficient ink absorbing capacity of the recording material. When the thickness of the ink absorbing layer is raised as the countermeasure against the forgoing problems, rise problems such as that a crack tends to be formed on the layer and the production cost is increased since the coating speed of the layer is lowered since the drying speed in the production process is decreased.

When a porous substrate such as usual paper, high quality paper, coated paper or casting coated paper is used as the support, some of them satisfy the ink absorption capacity since the ink is permeated into the support. In the case of the support satisfying the ink absorbing capacity, however, problems rise such that an undulation caused by the absorption and the drying of the ink is occurred at the image printed area so that the image quality is considerably degraded, and the smoothness and the glossiness are lowered and a clear image is difficultly formed since the maximum density is lowered by the permeation of the dye into the support.

Japanese Patent Publication Open to Public Inspection, herein after referred to as JP O.P.I., No. 1-282399 discloses that the ink acceptability is improved by a recording paper constituted by a support, an ink acceptable layer mainly constituted by an acryl resin having a glass transition point of not more than 20° C. and a surface layer mainly constituted by a resin having a glass transition point of not less than 80° C. each provided on the support in this order. JP O.P.I. No. 5-51470 discloses that the adhering ability between the support and the ink acceptable layer, the water fastness and image quality are improved by providing a porous layer which is composed of a water dispersible polymer and a rosary like-shaped colloidal silica and has an oil absorbing amount of not less than 1 ml/m² between the support and the ink acceptable layer. However, the effects of the foregoing disclosures are insufficient.

JP O.P.I. No. 5-85035 proposes to inhibit the irregularity of the surface by providing an interlayer composed of a pigment and an adhesive having a glass transition point of from 30 to 60° C. between the usual paper support and the ink-receiving layer. JP O.P.I. No. 8-300806 discloses that the resistively against scratch occurred at the time of conveying in the printer and the ink acceptability are improved by providing an anchor layer composed of a self adhering pigment between the support composed of wood pulp and the ink-receiving layer. However, the effect of improving the ink absorption ability utilizing the ink absorption ability of the support are insufficient when such a porous material such as paper is used as the support according to the foregoing methods.

JP O.P.I. No. 5-46317 discloses that the ink absorption ability and the chromaticness of the color image are improved by the use of a recording paper having a coated layer provided on a support, which is composed of a pigment and a polymer formed by reacting polyvinyl alcohol, methyl methacrylate and methacrylic acid. JP O.P.I. No. 7-276787 discloses that the resolving power and the water fastness of the recording material are improved by the use of a recording paper in which an emulsion of a copolymer derived from a ethylenic unsaturated monomer or a diene monomer polymerized by an emulsified-polymerization in the presence of a vinyl alcohol polymer having a mercapto group at the terminal thereof as the dispersion stabilizer is used as the surface sizing agent or the binder of the pigment to be coated on the support surface. However, the effects of coating of the layer containing the forgoing polymer are insufficient since sufficient image density and glossiness cannot be obtained.

When an ink-receiving layer having a high porosity is coated on a porous support such as paper, the smoothness and the glossiness of the surface of the coated ink-recording layer tends to be degraded and the production of it is made difficult since the coated layer is easily cracked.

JP O.P.I. No. 11-245506 discloses that a high texture, image density, chromaticity and glossiness can be obtained when an ink-receiving layer composed of a white pigment having a resistively against dissolution and alumina boehmite is coated on a fiber substrate. JP O.P.I. No. 2000-33771 proposes an ink-jet recording material composed of a paper base and a layer containing barium sulfate and thermoplastic hollow fine beads. However, as a result of the investigation by the inventors, an ink-receiving layer with a high porosity coated on a layer composed of a white pigment and a binder such as gelatin tends to be cracked even when the pigment is given the resistively against water dissolution. Accordingly, the smoothness of the coated surface of the ink-receiving layer is degraded and the ink-receiving layer is difficultly made thinner.

Moreover many measures such as calendaring of the coated layer and providing of a coated layer by casting method are proposed for improving the smoothness and the glossiness. However, it is difficult at the present condition to provide a recording material with a low cast, a high density and a high quality since the coating speed cannot be raised and the production process becomes complicated when the foregoing proposals are practiced.

Consequently, it is demanded to solve the foregoing problems.

### SUMMARY OF THE INVENTION

The object of the invention is to provide an ink-jet recording material excellent in the ink absorbing ability, smoothness, conveying ability in the printer and that giving an image with a high density and a high quality. In detail, the object is to provide an ink-jet recording material giving an image with a high density and a high quality, in which the thickness of the ink-receiving layer to be coated on a support by raising the ink absorption ability thereof.

The foregoing object of the invention can be attained by the following constitution.

Item.1

An ink-jet recording material comprising a support having thereon a first layer and an ink-receiving layer in that order,

wherein the first layer comprising a resin polymerized by emulsion polymerization in the presence of a polymer dispersant having at least a hydroxyl group; and

the ink-receiving layer comprising a water-soluble binder and inorganic particles having an average particle diameter of 3 to 200 nm.

Item.2

The ink-jet recording material of Item.1, wherein the support is a porous substrate.

Item.3

The ink-jet recording material of Item.1, wherein the first layer comprises inorganic particles.

Item.4

The ink-jet recording material of Item.3, wherein the ink-receiving layer comprises a resin polymerized by emulsion polymerization in the presence of a polymer dispersant having at least a hydroxyl group.

Item.5

The ink-jet recording material of Item.4, wherein the weight ratio of the inorganic particles to the polymerized resin (the weight of the inorganic particles/the weight of the polymerized resin) in the first layer is within the range of 2 to 10, and the weight ratio of the inorganic particles to the polymerized resin (the weight of the inorganic particles/the weight of the polymerized resin) in the ink-receiving layer is not less than 15.

Item.6

The ink-jet recording material of Item.1, wherein the polymer dispersant is a polyvinyl alcohol polymer.

Item.7

The ink-jet recording material of Item.6, wherein the average polymerization degree of the polyvinyl alcohol is within the range of 1500 to 5000.

Item.8

The ink-jet recording material of Item.1, wherein the polymerized resin has a glass-transition temperature of not more than 20° C.

Item.9

The ink-jet recording material of Item.1, wherein the inorganic particle is silica obtained by a gas phase method.

Item.10

The ink-jet recording material of Item.1, wherein the water-soluble binder is a polyvinyl alcohol.

Item.11

The ink-jet recording material of Item.10, wherein the weight ratio of the inorganic particles to the polyvinyl alcohol (the weight of the inorganic particles/the weight of the polyvinyl alcohol) in the ink-receiving layer is within the range of 3 to 20.

Item. 12

The ink-jet recording material of Item.1, wherein at least one of the ink-receiving layer and the first layer is hardened with a hardening agent.

Item.13

The ink-jet recording material of Item.1, wherein at least one of the ink-receiving layer and the first layer comprises a cationic compound.

Item.14

The ink-jet recording material of claim 13, wherein the cationic compound is a polymer including a monomer unit represented by the following General Formula (1),

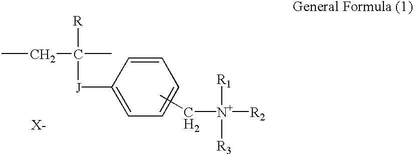

wherein R represents a hydrogen atom or an alkyl group; each of R₁, R₂ and R₃ represents an alkyl group or benzyl group, independently; J represents a single bond or a divalent organic group; and X⁻represents an anion group.

Item.15

### DETAILED DESCRIPTION OF THE INVENTION

The invention is described in detail below. A known support can be used as the support of the ink-jet recording material according to the invention, hereinafter simply referred to as recording material. The effects of the invention for improving of the absorption ability and the spread of the ink are enhanced when the support is a porous substrate.

The porous substrate relating ink-jet recording material relating to the invention is described below. As the porous substrate relating to the invention, for example, a sheet or board containing usual paper, synthesized paper, cloth or wood are usable. Among them, paper is most preferable since the paper is excellent in the water absorption ability itself and in the cost. Paper support is described below.

As the raw material of the paper, broad-leaved tree pulp is preferably used even though one mainly constituted by wood pulp including a chemical pulp such as LBKP and NBKP, mechanical pulp such as GP, CGP, RMP, TMP, CTMP and PGW, recycled paper pulp such as DIP are usable. Kraft pulp, sulfite pulp, chemithermomechanical pulp and chemimechanical pulp may be used singly or in combination as the broad-leaved pulp. Various fiber-like materials such as synthesized pulp, synthesized fiber and inorganic fiber optionally may be used as the raw material according to necessity.

It is preferable that the pulp is subjected to a breaching treatment by a breaching agent such as a peroxide compound for raising the whiteness. The breaching treatment is preferably applied after the cooking, chlorine treatment, alkaline treatment or extraction or purification, breaching by hypochlorite, breaching by chlorine dioxide, multi-step breaching treating by the combination thereof, furthermore, reduction breaching treatment by hydrosulfite or sodium boron hydride according to necessity, of the pulp. It is further preferably that the breaching treatment by the peroxide compound under an alkaline condition is applied as the last treatment of the pulp after the cooking and known pulp breaching treatment. An alkaline treatment, extraction or purification further may be applied.

A known additive such as a sizing agent, a pigment, a paper strength raising agent, a fixing agent, a fluorescent whitening agent, a wetting agent and a cationizing agent may be added to the paper according to necessity. The sizing agent such as a higher fatty acid, an alkylketene dimmer, rosin, paraffin wax, an alkenylsuccinic acid and a petroleum resin emulsion may be added. The pigment such as a particle of calcium carbonate, talk, titanium oxide and a urea resin; the paper strength raising agent such as starch, polyacrylamide and polyvinyl alcohol; and the fixing agent such as aluminum sulfate and a cationic polymer electrolyte are usable. However, the additive is not limited to the above-mentioned.

The paper support can be produced by mixing a fiber material such as the wood pulp and the additives and making paper by a paper making machine such as a fourdrinier paper machine, a cylinder paper machine and a twin-wire paper machine. The paper may be subjected to a size press treatment with starch or polyvinyl alcohol, various coating treatments and a calendar treatment may be applied at or after the paper making process.

The density of the paper according to JIS-P-8118 is usually from 0.7 to 1.2 g/m². The stiffness of the paper is preferably from 20 to 200 g under the condition defined in JIS -P 8143.

The pH of the paper is preferably from 5 to 9 when the measurement is carried out by the hot water extract method defined by JIS-P-8113.

In the invention, the support may be subjected to a corona discharge treatment, a subbing treatment and coating of an interlayer before the coating of the ink-receiving layer.

The thickness of the support is preferably from 50 to 350 mμ, more preferably from 80 to 300 mμ, particularly preferably from 140 to 220 mμ.

From the viewpoint of demonstrating the effect of the invention, it is preferable that the paper substrate used in the invention comprises a pulp having a weight-average fiber length of 0.4 to 1.2 mm measured by the Paper Pulp Testing Method No. 52 of JAPAN TAPPI. More preferably, the weight-average fiber length is 0.5 to 0.9 mm, and further, 0.55 to 0.65 mm is specifically preferred.

As a method to adjust the weight-average fiber length after beating, a method using a pulp, which is made from a plant having the fiber length within the preferable range of the present invention, and a method adjusting the fiber length by beating can be used. However, the latter method is more suitable for practical use. As equipments for beating, a beater, a conical refiner or a disk refiner can be used by adjusting them in a condition, in which the cutting beating easily occurs.

Hereinafter, the resin polymerized by emulsion polymerization in the presence of the polymer dispersant having a hydroxyl group according to the invention is described below.

The resin polymerized by emulsion polymerization in the present invention represents a resin obtained by polymerizing oil-soluble monomers, which is kept in an emulsion state in an aqueous solution containing a dispersant, with utilizing a polymerization initiator. As the dispersant used in the emulsion polymerization, generally, low molecular dispersants such as an alkyl sulfonic acid salt, an alkylbenzene sulfonic acid salt, a diethyamine, an ethylenediamine and a quaternary ammonium salt, and polymer dispersants such as a polyoxyethylene nonylphenylether, a polyoxyethylenelauric ether, a hydroxyethyl cellulose and a polyvinyl pyrrolidone can be cited.

The polymer dispersant having a hydroxyl group used in the invention is a polymer dispersant having a weight-average molecular weight of not less than 10,000, in which a hydroxyl group is substituted at the side chain or the terminal thereof. Examples of the polymer dispersant having a hydroxyl group include a copolymer of an acryl polymer such as sodium polyarylate and acrylamide with 2-ethyl hexyl acrylate, a polyether such as polypropylene glycol and polyvinyl alcohol. Polyvinyl alcohol is particularly preferred.

The polyvinyl alcohol to be used as the polymer dispersant in the invention includes a modified polyvinyl alcohol such as a cationically modified polyvinyl alcohol, an anionically modified polyvinyl alcohol having an anionic group such as a carboxyl group and a silyl-modified polyvinyl alcohol having a silyl group, in addition to an usual full saponified or partially saponified polyvinyl alcohol produced by saponification of polyvinyl acetate.

Usually, the higher the average polymerization degree of the polyvinyl alcohol, the greater the effect to prevent an occurrence of crack during forming the ink-receiving layer. However, polyvinyl alcohol having the average polymerization degree of not more than 5000 can be dealt easily during producing because the viscosity is not relatively high. Thus, the average polymerization degree of the polyvinyl alcohol is preferably from 300 to 5,000, more preferably from 1500 to 5000 and most preferably from 3000 to 4500. The saponification degree of the polyvinyl alcohol is preferably from 70 to 100 mole-percent and more preferably 80 to 99.5 mole-percent.

Examples of the resin polymerized by emulsion polymerization in the presence of the polymer dispersant include a homopolymer and a copolymer of an ethylene monomer such as an acrylic acid ester, a methacrylic acid ester, a vinyl compound and a styrene compound and a diene monomer such as butadiene and isoprene, such as an acryl resin, a styrene-butadiene resin and an ethylene-vinyl acetate resin.

The polymerized resin having a high softness at an ordinary temperature is suitable; one capable of forming a continuous layer at the ordinary temperature is preferable. The glass transition point Tg of a film formed by the resin is preferably not more than 40° C., more preferably from −40 to 10° C.

The average diameter of the polymerized resin used in the invention is preferably 0.01 to 2.0 μm, more preferably 0.05 to 1.0 μm, and most preferably 0.05 to 0.50 μm. If an polymerized resin having too large average diameter are contained in a coating material, the clarity of the coated layer tends to decrease and a decrease of the density of printed characters tends to occur.

The resin polymerized by emulsion polymerization in the presence of the polymer dispersant having a hydroxyl group according to the invention can be produced by a known method without any limitation. Concrete examples of the polymerized resin include a vinyl acetate type emulsion such as Vinisol 480 and Vinisol 2023, manufactured by Daido Kasei Kogyo Co., Ltd., VINYBLAN 1108W and VINYBLAN 1084W, manufactured by Nissin Kagaku Kogyo Co., Ltd., an acryl type emulsion such as VINYBLAN 2597 and VINYBLAN 2561, manufactured by Nissin Kagaku Kogyo Co., Ltd., and a vinyl acetate-ethylene type emulsion such as Sumikaflex S-400, Sumikaflex S-401 and Sumikaflex S-405, manufactured by Sumitomo Kagaku Co., Ltd.

The layer containing the resin polymerized by emulsion polymerization in the presence of the polymer dispersant having a hydroxyl group according to the invention preferably contains an inorganic particle. The layer may contain another water-soluble binder or a hydrophobic binder in addition to the polymerized resin according to the invention. When such the binder is used in combination, the water-soluble binder is preferred. When a coating liquid is coated and dried on the porous substrate such as the paper support, the water-soluble resin such as polyvinyl alcohol is permeated into the space of the porous substrate and acts as a filling agent after dried so as to tend to degrade the ink absorption ability of the substrate. Consequently, the amount of the water-soluble binder is preferably a little for obtaining the ink absorption ability according to the invention when the water-soluble binder is used in combination. The weight ratio of the inorganic particle to the water-soluble binder is preferably not less than 25, more preferably not less than 50.

The average diameter of the inorganic particles is preferably not more than 200 nm, more preferably from 3 to 200 nm, further preferably from 5 to 100 nm, most preferably from 10 to 70 nm, for enhancing the effect of the invention. The inorganic particle may be used either in the form of primary particle uniformly dispersed in the binder or in the form of secondary coagulated particle dispersed in the binder; and the later form is preferable.

When the primary particle of the inorganic particle is used in the form of forming the secondary coagulated particle, the average diameter of the primary particles is preferably not more than 30 nm for obtaining the sufficient image density and the smoothness.

The lower limit of the average diameter of the primary particles is usually not less than 3 nm, particularly preferably not less than 6 nm from the viewpoint of the production even though there is no limitation on the low limit of the particle diameter.

Thus, the preferable construction of the first layer containing the polymerized resin in the present invention is a layer comprising inorganic particles having an average diameter of 5 to 100 nm and a resin polymerized by emulsion polymerization in the presence of the polymer dispersant having a hydroxyl group having an average diameter of 0.05 to 1.0 μm, and the weight ratio of the inorganic particles to the polymerized resin (the weight of inorganic particles/the weight of the polymerized resin) is 2 : 1 to 10 : 1. Further, it is more preferable that the average diameter of the polymerized resin is 0.05 to 0.5 μm, with respect to the effect of the present invention.

The inorganic particle and the water-soluble binder to be added to the layer containing the emulsified resin are the same as those to be added to the later-mentioned ink-receiving layer. However, the inorganic particle is preferably silica synthesized by a gas phase method (also referred as fumed silica).

The silica synthesized by a gas phase method has hydroxyl groups of about 2 or 3 per nm² on the particle surface, and the number of hydroxyl groups on the particle surface of the fumed silica is relatively fewer than that of the silica synthesized by a wet method. Thus, in the silica synthesized by a gas phase method, hydrogen bonding in the molecules is relatively difficult to occur, and the silica synthesized by a gas phase method has relatively large number of isolated hydroxyl groups. As the result to that, the power of hydrogen bond to other molecules is relatively large. It is considered that one of the effect of the present invention is increased by the hydrogen bond between the hydroxyl group of the polymer dispersant and the hydroxyl group on the surface of the inorganic particle, and therefore, the effect of the present invention is obtained well when the silica synthesized by a gas phase method is used in the layer containing the polymerized resin. In the similar reason, it is also considered that the effect of the present invention is obtained well when the inorganic particles having relatively small average diameter are used in the layer containing the polymerized resin, because the relative surface area is relatively large and the number of the hydroxyl group to form hydrogen bonds increases.

The ink-receiving layer according to the invention contains the inorganic particles having an average diameter of from 3 to 200 nm and the water-soluble binder. The average diameter of the inorganic particles is preferably from 5 to 100 nm, more preferably from 10 to 70 nm.

In the above-mentioned, the average diameter of the inorganic particles is determined by simple average (number average) of the diameters of optionally selected 100 particles measured by observation of the particle itself, or the cross-section or the surface of the porous layer by a scanning electron microscope. The particle diameter is defined by the diameter of a circle having the area the same as the projection area of the particle. The inorganic particle measured by above method may be a primary particle or a secondary particle. The average diameter of the inorganic particles in the present invention is defined as an average diameter of the inorganic particles having the highest order observed in the dried layer.

When inorganic particles having an average diameter of more than 200 nm are used in the ink-receiving layer, reducing of the glossiness of the recording material, lowering of the true circle degree of the dot formed by the ink-jet recording, unnecessary spread of the dot and lowering of the maximum density caused by irregular reflection on the surface are occurred so that a clear image is difficultly obtained and the effect of the invention cannot be obtained.

The average particle diameter of not more than 100 nm is preferred from the viewpoint of enhancement of the effect of the invention. The inorganic particle may be used either in the form of primary particle uniformly dispersed in the binder or in the form of secondary coagulated particle dispersed in the binder; and the later form is preferable.

When the primary particle of the inorganic particle is used in the state of the secondary coagulated particle, the average diameter of the primary particles is preferably not more than 30 nm from the viewpoint of the glossiness.

The lower limit of the average diameter of the inorganic particles is usually not less than 3 nm, particularly preferably not less than 6 nm from the viewpoint of the production even though there is no limitation on the low limit of the particle diameter.

Example of the inorganic particle to be added to the ink-receiving layer or may be added to the layer containing the polymerized resin according to the invention includes a white pigment such as light calcium carbonate, heavy calcium carbonate, magnesium carbonate, kaolin, clay, talk, calcium sulfate, barium sulfate, titanium dioxide, zinc oxide, zinc hydroxide, zinc sulfide, zinc carbonate, hydorotalcite, aluminum silicate, diatom earth, calcium silicate, magnesium silicate, synthesized amorphous silica, colloidal silica, alumina, colloidal alumina, pseudo boehmaite, aluminum hydroxide, lithopne, zeolite and magnesium hydroxide.

As the inorganic particle, one having an anionic surface and a fixing ability to the dye and one having a cationic surface and no fixing ability to the dye are usable.

When the inorganic particle having the anionic surface is used, a cationic polymer is usually used with together. In such the case, the cationic polymer is remained on the surface of the inorganic particle and made immovable, and the dye is fixed by the immovable cationic polymer so as to be made immovable.

In the invention, a fine particle having a low refractive index and a small average diameter is preferable as the inorganic particle, for example, particles of silica, colloidal silica, calcium silicate, calcium carbonate, bemite aluminum hydroxide and a hydrate thereof. Among them, the particles of silica are preferred.

In the invention, silica and colloidal silica produced by a gas phase method are preferred as the inorganic particle having the anionic surface since they are low in the cost and have a low refractive index by which a high reflective density can be obtained. From the viewpoint of the effect of the invention, particles of fumed silica are most preferred.

In case the silica synthesized by a gas phase method is used in a state of secondary coagulated particles formed by primary particles, the primary particle having an average diameter of not more than 30 nm is preferably used from the viewpoint of glossiness. The lower limit of the average diameter of the primary particles is preferably not less than 3 nm, particularly preferably not less than 6 nm from the viewpoint of the production even though there is no limitation on the low limit of the particle diameter.

Example of the inorganic particle having the cationic surface include an inorganic particle in which the charge of the surface is changed to cationic by coupling the surface thereof with a silane coupling agent having a quaternary ammonium salt groups such as that described in JP O. P. I. No. 8-34160.

The production method of the silica particle is roughly classified into a dry method or gas phase method and a wet method. A method by gas phase hydrolysis of silicon halide at a high temperature, a flame hydrolysis method, and a method, an arc method, by which a mixture of silica sand and coke are heated, reduced and vaporized by arc and the vaporized product is oxidized by air are know as the dry method. A method by which active silica is formed by acid decomposition of silicate and the active silica is excessively polymerized so as to be coagulated and precipitated is known as the wet method.

In the invention, the silica synthesized by the gas phase method is most preferable among the various kinds of silica particle. The silica particle synthesized by the gas phase method is usually a silica powder obtained by burning a mixture of silicon tetrachloride with hydrogen and oxygen at a high temperature, which has an average diameter of the primary particles of from 5 to 500 nm. In the invention, one having the average diameter of primary particle within the range of from 6 to 30 nm is preferable from the viewpoint of glossiness of the recording material.

Examples of the silica produced by the gas phase method available in the market include various kinds of Aerogel manufactured by Nihon Aerogel Co., Ltd.

The colloidal silica preferably used in the invention is one produced by heating and ripening a silica sol which is obtained by a double decomposition by an acid or a treatment by an ion-exchange resin layer of sodium silicate. The use of the colloidal silica for the ink-jet recording material is described, for example, in JP O. P. I. Nos. 57-14091, 60-219083, 60-219084, 61-20792, 61-188183, 63-17807, 4-93284, 5-278324, 6-92011, 6-183134, 6-297830, 7-81214, 7-101142, 7-179029 and 7-137431, and International Patent Publication No. W094/26530.

The preferable average particle diameter of the colloidal silica is usually from 5 to 100 nm. The average particle diameter from 7 to 30 nm is particularly preferable.

The silica synthesized by the gas phase method and the colloidal silica may be either one cationically modified on the surface thereof or one treated by Al, Ca, Mg or Ba.

The recording material contains the inorganic particle and has the ink-receiving layer having a porous structure. When the porosity of the ink-receiving layer is formed by containing the inorganic particle, it is preferable to add a water-soluble binder into the ink-receiving layer for stably forming the layer.

Examples of the water-soluble binder to be contained in the ink-receiving layer include polyvinyl alcohol, gelatin, poly(ethylene oxide), polyvinylpyrrolidone, polyacrylic acid, polyacrylamide, polyurethane, dextran, dextrin, carrageenan λ and ι, agar, pullulan, water-soluble poly(vinyl butyral), hydroxyethyl cellulose and carboxymethyl cellulose. These water-soluble binders may be used singly or in combination. Among them, polyvinyl alcohol is preferred as the water-soluble binder in the invention.

The polyvinyl alcohol to be preferably used in the ink-receiving layer in the invention includes a modified polyvinyl alcohol such as a cationically modified polyvinyl alcoholat the terminal thereof, and an anionically modified polyvinyl alcohol having an anionic group in addition to an usual polyvinyl alcohol produced by saponification of poly(vinyl acetate).

The polyvinyl alcohol obtained by hydrolysis of polyvinyl acetate is preferably one having an average polymerization degree of not less than 1,000, particularly from 1,500 to 5,000.

The saponification degree of the polyvinyl alcohol is preferably from 70 to 100%, particularly preferably from 80 to 99.5%.

Example of the cationically modified polyvinyl alcohol includes a polyvinyl alcohol having a primary, secondary of tertiary amino group or a quaternary ammonium group at the main chain or the side chain such as that described in JP O. P. I. No. 61-10483. Such the modified polyvinyl alcohol can be obtained by saponification of a copolymer of an ethylenic unsaturated monomer having the cationic group and vinyl acetate.

Examples of the ethylenic unsaturated monomer having the cationic group include trimethyl-(2-acrylamido-2,2-dimethylethyl) ammonium chloride, trimethyl-(3-acrylamido-3,3-dimethylpropyl) ammonium chloride, N-vinylimidazole, N-vinyl-2methylimidazole, N-(3-dimethylaminopropyl)-methacrylamide, hydroxylethyltrimethylammonium chloride, N,N,N-trimethyl(3-methacrylamidopropyl)ammonium chloride and N-(1,1-dimethyl-3-dimethylaminopropyl)acrylamide.

The ratio of the cationically modifying group-containing monomer to vinyl acetate in the cationically modified polyvinyl alcohol is from 0.1 to 10 mole-percent, preferably from 0.2 to 5 mole-percent.

Examples of the anionically modified polyvinyl alcohol include a polyvinyl alcohol having an anionic group such as that described in JP O. P. I. No. 1-206088, a copolymer of polyvinyl alcohol and a vinyl compound having a water solubilizing group such as that described in JP O.P.I. Nos. 61-237681 and 63-307979, and a modified polyvinyl alcohol having a hydroxyl group such as that described in JP O.P.I. No. 7-285265.

Examples of nonionically modified polyvinyl alcohol include a polyvinyl alcohol derivative in which a polyalkylene oxide group is added to a part of the polyvinyl alcohol such as that described in JP O.P.I. No. 7-9758, and a block copolymer of a vinyl compound having a hydrophobic group and vinyl alcohol such as that described in JP O.P.I. No. 8-25795.

Two or more kinds of the polyvinyl alcohol may be used in combination, which are different from each other in the polymerization degree and the kind of modification.

The ratio of the inorganic particle to the water-soluble binder in the ink-receiving layer according to the invention is preferably not less than 3 times and not more than 20 times by weight for obtaining a high porosity and a high layer strength can be obtained. When the ratio is 3 times or more, the high porosity for obtaining sufficient ink acceptability and a sufficient layer strength after the ink-jet printing. From such the viewpoint, the weight ratio of the inorganic particle to the water-soluble binder is more preferably 6 times or more.

The ink-receiving layer of the present invention can contains the resin polymerized by emulsion polymerization in the presence of the polymer dispersant having a hydroxyl group in addition to the above-described binder. However, in case the polymerized resin is additionally used, the amount of the polymerized resin is preferably small from the viewpoint of the effect of the present invention. The weight ratio of the inorganic particle to the polymerized resin is preferably not less than 20, and more preferably not less than 50. Further, in case the ink-receiving layer is constructed with a plurality of layers, it is preferable that the outermost layer of the ink-receiving layer does not contain the polymerized resin used in the present invention.

In the present invention, it is required that the ink-jet recording material has a plurality of layers comprising a first layer containing a resin polymerized by emulsion polymerization in the presence of the polymer dispersant having a hydroxyl group, and an ink-receiving layer containing a water-soluble binder and inorganic particles. If the recording material is formed by only the first layer containing the polymerized resin, it is difficult to obtain the effects of the present invention from the viewpoint of smoothness and the Maximum density. If the recording material is formed by only the ink-receiving layer containing the water-soluble binder and the inorganic particles, it become difficult to obtain the effects of the invention satisfactory, from the viewpoint of ink absorptivity and bleeding.

Porosity

The pore volume is a difference of the thickness of the porous layer and the sum of the volume of the solid ingredients namely the binder and various components such as filler. For instance, when the porous layer contains 6 g/m² of an inorganic particle with a specific gravity of 2.0, 1 g/m² of a water-soluble binder with a specific gravity of 1.0 and 1 g/m² of a polymer cationic mordant with a specific gravity of 1.0, and the dry thickness of the porous layer is 10 μm, the pore volume of the layer is 5 ml/m² according to the following equation.

10−(6/2.0)−(1/1.0)−(1/1.0)=5

Besides, in some cases, fine cracks are locally formed on the coated layer in the course of shrinking of the layer by drying after coating of the porous layer, when the rigidity of the layer is excessively high. The upper limit of the ratio of the inorganic particle to the water-soluble binder in the ink-jet recording material according to the invention is usually 20, preferably 8.

In the ink-jet recording material according to the invention, the coated amount of the solid ingredient in the dried state is preferably from 7 to 30 g/M² even though the coated amount of the layer according to the invention is generally decided by the porosity of the layer or the required pore volume. The coated amount of the solid ingredient in the dried state of from 7 to 30 g/m² is preferable from the viewpoint of the cockling, glossiness and maximum density, and the crack of the porous layer formed in the course of the shrinking of the layer in the drying process can be easily inhibited. Moreover, the production cost can be reduced since the drying load of such the layer is low and the productivity is high.

A hardener may be used to the ink-receiving layer and the polymerized resin-containing layer according to the invention. As the hardener usable in the invention, boric acid and its salt are preferable. However, another known hardener also can be used. Generally, the hardener is a compound having a group capable of reacting with the water-soluble binder or a compound capable of accelerating the reaction between the two kinds of groups contained in the water-soluble binder different from each other. The hardener is suitably elected in accordance with the kind of the water-soluble binder. Concrete examples of the hardener include an epoxy hardener such as glycidyl ether, ethylene glycol glycidyl ether, 1,4-butanediol glycidyl ether, 1,6-diglycidylcyclohexane, N,N-diglycidyl-4-glycidyloxianiline, solbitol polyglycidyl ether and glycerol polyglycidyl ether; an aldehyde hardener such as formaldehyde and glyoxal; an active halogen hardener such as 2,4-dichloro-4-hydroxy-1,3,5-s-triazine; an active vinyl compound such as 1,3,5-trisacryloyl-hexahydro-s-trazine; and aluminum alum.

The boric acid and its salt are an oxygen acid having a boron atom as the center atom, concretely orthoboric acid, diboric acid, metaboric acid, tetraboric acid, pentaboric acid and octaboric acid and their salts.

The boric acid having the boron atom and its salt to be used as the hardener may be used in a state of single aqueous solution or a mixture of two or more kinds. An aqueous solution of a mixture of boric acid and borax is particularly preferred.

Boric acid and borax each can be added only in a state of relatively diluted aqueous solution but they can be made to a concentrated solution by mixing both of the compounds so as to concentrate the coating liquid. An advantage can also be obtained that the pH value of the aqueous solution to be added can be relatively freely controlled.

The adding amount of the hardener is preferably from 1 to 200 mg, more preferably from 2 to 100 mg, per gram of the water-soluble binder.

When the inorganic particle having the anionic surface is used in the ink-receiving layer or the polymerized resin-containing layer, it is preferable to add the cationic polymer having a primary, secondary or tertiary amino group or an ammonia group, which have a dye fixing ability, for improving the water proof ability and the anti-spreading ability of the image.

Know cationic polymers, for example, polyethyleneimine, polyacrylamine, dicyanodiamidopolyalkylenepolyamine, a condensate of dialkylamine and epichlorohydrin, polyvinylamine, polyvinylpyridine, polyvinylimidazole, a condensate of diallyldimethylammonium salt and a quarternarized compound of polyacryl ester can be used as the cationic polymer. Ones described in JP O.P.I. Nos. 10-193776, 10-217601 and 11-20300 are particularly preferred.

A cationic polymer having a quaternary ammonium base is preferable since such the compound has a sufficiently high mordant ability. A homopolymer of the monomer having the quaternary ammonium base or a copolymer of such the monomer and one or more other monomers capable of forming a copolymer is particularly preferred. Further, the cationic polymer including a monomer unit represented by above General Formula (1) is more preferable.

In the General Formula (1), as the preferable alkyl group represented by R is a methyl group. Preferable alkyl group represented by R₁, R₂ or R₃ is a methyl group, ethyl group or a benzyl group. The divalent organic group represented by J preferably represents a group of —CON(R′)—. R′ represents a hydrogen atom or an alkyl group. As the anion group represented by X, halogen ion, acetic acid ion, methyl sulfonic ion, and p-toluene sulfonic acid can be cited.

The cationic polymer can be a homo-polymer constructed with the monomer units represented by General Formula (1) or a co-polymer constructed with the monomer units represented by General formula (1) and other monomer units. As the monomer unit being able to constructing the co-polymer, a cationic monomer unit other than the monomer unit represented by General Formula (1) or a monomer unit having no cationic group can be cited.

Examples of the monomer having the quaternary ammonium group are shown below.

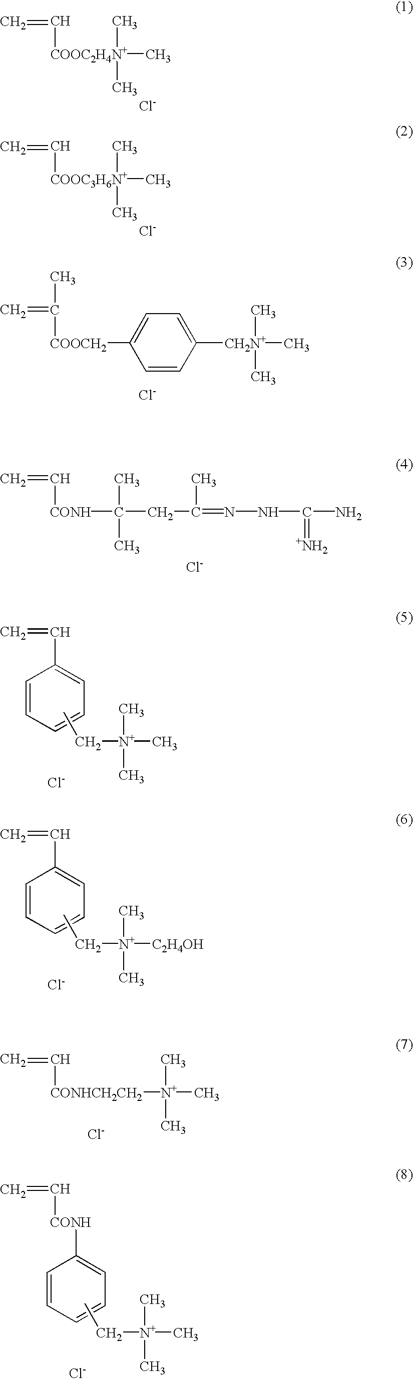

The monomer capable of copolymerizing with the quaternary ammonium base is a compound having an ethylenic unsaturated group. Examples of such the monomer are as follows.

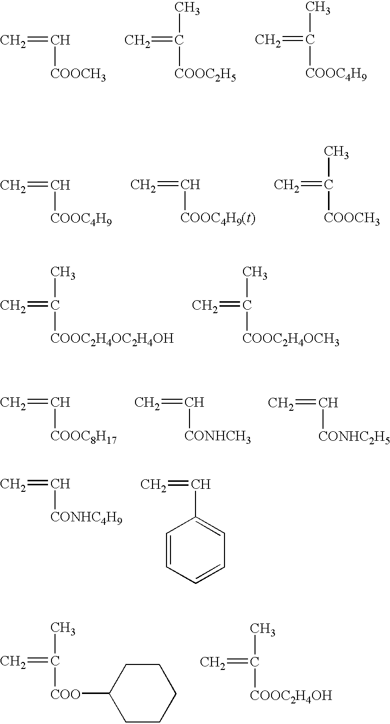

Concrete examples of the cationic polymer preferably usable in the invention are shown below. The invention is not limited to them.

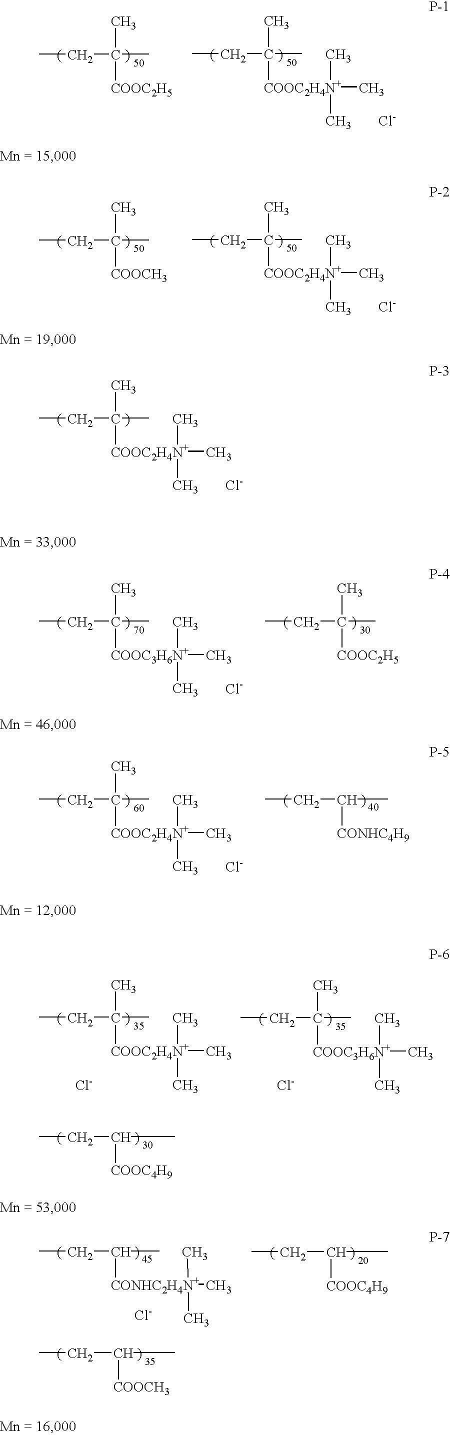

When the cationic polymer having the quaternary ammonium base is a copolymer, the ratio of the cationic monomer is usually not less than 10 mole-percent, preferably not less than20 mole-percent, particularly preferably not less than 30 mole-percent.

The monomer having the quaternary ammonium base may be contained singly or in combination of two or more kinds of them.

Although the cationic polymer having the quaternary ammonium base usually has high water solubility resulted from the quaternary ammonium base, some times the polymer is not sufficiently dissolved in water according to the constitution or ratio of the monomer having no quaternary ammonium base. However, ones capable of being dissolved in a mixed solvent of water and a water-permissible solvent can be used in the invention.

The water-permissible solvent is an organic solvent usually capable of being dissolved in water in a ratio of not less than 10%, for example, an alcohol such as methanol, ethanol, isopropanol and n-propanol; a glycol such as ethylene glycol, diethylene glycol and glycerol; an ester such as ethyl acetate and propyl acetate; a ketone such as acetone and methyl ethyl ketone; and an amide such as N,N-formamide. In such the case, the using amount of the organic solvent is preferably smaller than that of water.

The weight average molecular weight is the value in terms of polyethylene glycol value determined by gel permeation chromatography.

Sometimes a coagulum is considerably formed when a solution of the cationic polymer is added to the dispersion containing the inorganic particle having the anionic surface. Such the phenomenon is difficultly occurred when the weight average molecular weight of the cationic polymer is not more than 100,000. Accordingly, such the condition is preferable since an almost uniform dispersion with no coarse particle can be easily obtained. An excellent glossiness can be expected as to the kink-jet recording material produced by the use of such the dispersion. It is further preferable form the same viewpoint that the weight average molecular weight is not more than 50,000. The lower limit of the weight average molecular weight is usually 2,000 from the viewpoint of the water-proof ability of the dye.

The ratio of the inorganic particle to the cationic polymer can be varied depending on the kind and average diameter of the inorganic particle and the kind and weight average molecular weight of the cationic polymer. In the invention, the ratio is preferably from 1:0.01 to 1:1, more preferably from 1:0.01 to 1:0.3, particularly preferably from 1:0.05 to 0.2, for replacing the surface of the inorganic particle by the cationic polymer to stably fix the dye.

When the ratio is within the foregoing range, the anionic ingredient of the inorganic particle is completely covered by the cationic component. Consequently, there is no apprehension about the formation of coarse particle caused by the combining of the anionic part of the inorganic particle and the cationic part of the cationic polymer.

Besides, an inorganic particle having the cationic surface may be used as the inorganic particle. In such the case, the inorganic particle itself has the dye fixing ability. Silica produced by the gas phase method and treated by a surface cationizing treatment, colloidal silica treated by a surface cationizing treatment, alumina, colloidal alumina and pseudobemite are preferably used as the inorganic particle having the cationic surface.

Various additives may be added according to necessity into an optional layer provided on the side of the ink-receiving layer of the ink-jet recording material of the invention.

The following known additives may be added: for example, an UV absorbent described in JP O.P.I. Nos. 57-74193, 57-87988 and 62-261476; an anti-color fading agent, various kinds of anionic, cationic or nonionic surfactant described in JP O.P.I. Nos. 57-74192, 57-87989, 60-72785, 61-146591, 1-95091 and 3-13376; a fluorescent whitening agent; a pH controlling agent such as sulfuric acid, phosphoric acid, acetic acid, citric acid, sodium hydroxide, potassium hydroxide and potassium carbonate, an anti-foaming agent; a lubricant such as diethylene glycol, an antiseptic agent, a thickener, an antistatic gent and a matting agents described in JP O.P.I. Nos. 59-42993, 59-52689, 62-280069, 61-242871 and 4-219266.

For example, the foregoing cationic polymer or a water-soluble poly-valent metal ion may be added for raising the water fastness and the anti-ink-spreading ability to the ink after the image recording.

Examples of the water-soluble poly-valent metal ion include a di-valent metal ion such as Mg²+, Ca²+and Zn²+, a tri-valent metal ion such as A1³+ and a tetra- or more-valent metal ion such as Ti⁴+. Such the poly-valent metal ion is added in a state of a salt such as sulfite, sulfate, nitrate, chloride, acetate and p-tolyenesulfonate. A water-soluble inorganic polymer such as poly(aluminum chloride) may be used as the water-soluble salt of poly-valent ion.

The cationic resin or the water-soluble poly-valent metal ion can be directly added to the coating liquid. Moreover, another method may be applied by which an aqueous solution of the cationic resin or the water-soluble poly-valent metal ion is over-coated and dried on the coated and dried recording material.

The porous ink-accept layer may be constituted by two or more layers. In such the case, the two or more layers may be the same as or different from each other.

The ink-jet recording material according to the invention is a recording material which at least has the first layer containing the resin polymerized by emulsion-polymerization in the presence of the polymer dispersant having a hydroxyl group and, coated thereon, the layer containing the water-soluble binder and the inorganic particle having an average diameter of from 3 to 200 nm. The coated layer may has two or more layers. In such the case, the ratio of the inorganic particle to the water-soluble binder in each of the two or more ink-receiving layers may be the same as or different from each other.

Various kinds of backing layer may be provided on the surface opposite to the ink-receiving layer coated surface for preventing the caring, adhesion and ink transfer occurred when the materials are piled just after the printing.

The recording material according to the invention having the above-mentioned constitution can be produced, for example, by the following method.

First, the foregoing materials for forming the coated layer are added to a suitable solvent such as water, alcohol or various organic solvents to prepare the coating liquid, and the liquid is coated is coated on the foregoing support and dried to form a coated layer.

It is most preferable that the layer containing the resin polymerized by emulsion-polymerization in the presence of the polymer dispersant having a hydroxyl group and the ink-receiving layer containing the water-soluble binder and the inorganic particle having an average diameter of from 3 to 200 nm are simultaneously coated to obtain more preferable ink absorption ability of the finished recording material. Particularly, the recording material having high ink absorption ability can be obtained when the coating layers according to the invention are simultaneously coated on the porous substrate since the ink absorption ability of the porous substrate is practically utilized. As a result of that, the production cost of the recording material is lowered since the layer thickness can be reduced, and the recording material with a high image quality and a low cost can be provided.

The method for coating the layer on the support can be optionally selected from known methods. Examples of preferably usable coating method include a roller coating method, a rod-bar coating method, an air-knife coating method, a blade coater method, a spray coating method, a curtain coating method and an extrusion coating method using a hopper described in U.S. Pat. No. 2,681,294.

The coated layer is preferably dried by blowing warm air after cooling at once for raising the viscosity or gelling of the coated layer.

The temperature of the coating liquid of the layer is usually from 25 to 60° C., preferably from 30 to 50° C. The cooling is preferably carried out so that the surface temperature of the coated layer becomes to a temperature of not more than 20° C., more preferably from 5 to 15° C. It is preferable that the coated layer is dried by air with a temperature of from 20 to 60° C. for obtaining a uniform surface.

The wet thickness of the coated layer is about from 50 to 300 μm, preferably from 70 to 250 μm even though the wet layer thickness is varied according to the purpose of the layer. The coating speed is largely depended on the drying capacity and usually from 20 to 200 m/minute. The drying time is approximately from 2 to 10 minutes.

The aqueous ink to be preferably used for the ink-jet recording material according to the invention is described below.

The aqueous ink is a liquid for recording which usually contains a water-soluble dye, a liquid medium and an additive. A direct dye, acidic dye, basic dye, reactive dye and edible dye known in the field of the ink-jet recording can be used as the water-soluble dye; and the direct dye and the acidic dye are preferable.

The medium of the aqueous ink is mainly constituted by water and a high-boiling point organic solvent having a boiling point of not less than 120° C. is usually used together with the water to prevent the blocking at the end of the nozzle or the ink supplying pass by the dye separated by the drying of the ink. The high-boiling point solvent is required to have a vapor pressure remarkably lower than that of water to prevent the occurrence of the coarse separated matter by separation of the solid ingredient such as the dye when the water is evaporated. The high-boiling point point solvent is further required to have a high permissibility with water.

Many organic solvents having a high-boiling point are used for such the purpose. Concrete example of the solvent includes an alcohol such as ethylene glycol, propylene glycol, diethylene glycol, triethylene glycol, glycerol, diethylene glycol monomethyl ether, diethylene glycol monombutyl ether, triethylene glycol monombutyl ether, glycerol monomethyl ether, 1,2,3-butane-tri-ol, 1,2,4-butane-2,-tri-ol, 1,2,4-pentane-tri-ol, 1,2,6-hexane-tri-ol, thiodiglycol, triethanolamine and poly(ethylene glycol) having an average molecular weight not more than 300. Other than the above, dimethylformamide and N-methylpyrrolidone are also usable.

The aqueous ink may further contain another additive such as a pH controlling agent, a chelating agent, an anti-mould agent, a viscosity controlling agent, a surface tension controlling agent, a wetting agent, a surfactant and a an anti-rust agent.

The surface tension of the aqueous ink is preferably from 25×10⁻⁵ to 50×10⁻⁵ N/cm, more preferably from 28×10⁻⁵ to 40×10⁻⁵ N/cm, at 25° C. for the purpose of improving the wetting ability of the ink to the recording material and the stability of the sending out of the ink from the nozzle.

The viscosity of the aqueous ink is usually from 2×10⁻³ to 8×10³ Pa·s, preferably from 2.5×10³ to 5×10⁻³ Pa·s. The pH value of the aqueous ink is within the range of from 4 to 10.

The minimum volume of the droplet sent out from the ink nozzle is preferably 1×10^{31 3} to 30×10⁻³ nl since the dot having the minimum diameter of from 20 to 60 μm can be obtained on the recording material by such the droplet. The color image printed by the dot having such the diameter has a high image quality. It is more preferable that the droplet having a volume of 2×10⁻³ to 20×10⁻³ nl is sent out.

In a recording system in which at least magenta and cyan images are each formed by two kinds of ink different in the density from each other in a ratio of 2 or more, the dot is difficultly distinguished since the lower density ink is used in the highlight portion of the image. The invention can be applied to such the system.

The invention can be preferably applied to known various systems. Such the systems are described in detail in, for example, “Ink-jet kiroku gijutu no dokoo (Trend of the Ink-jet Recording Technology)” edited by K. Nakamura, Nihon Kagaku Joho Co., Ltd., Mar. 31, 1995.

### EXAMPLES

Although the invention is concretely described below referring examples, the embodiment of the invention is not limited thereto.

In the example, % is absolute dried weight % as long as any specific description is not added.

### Example 1

The pH value of 400 g of a 5% aqueous solution of polyvinyl alcohol having a polymerization degree of 1700,and a saponification degree of 88.5% was adjusted to 3.5. Then 50 g of methyl methacrylate and 50 g of butyl acrylate were added to the polyvinyl alcohol solution while stirring and the temperature of the mixture was raised to 60° C., and then 10 g of a 5% solution of ammonium persulfate was added to the mixture to start polymerization. After 15 minutes, 100 g of methyl methacrylate and 100 g butyl acrylate were gradually added spending 3 hours. After 5 hours, at this time the polymerization ratio was reached to 99.9%, the reaction liquid was cooled, and neutralized to pH of 7.0. Thus Polymerized Resin 1 was synthesized. The emulsion was dried by a vacuum drying apparatus at 60°. The glass transition point Tg of the resin measured by a differential scanning calorimeter was 5° C.

Polymerizexd Resins 2 through 10 shown in Table 1 were synthesized in a manner similar to that in the synthesis of Obtained Polymerized Resins were diluted by water, and the median diameter of Resins was measured by Particle Size Distribution Analyzer LA-700 (produced by HORIBA, Ltd.). The particle diameter of each of the Polynerized Resin was 0.4 μm.

TABLE 1

| | | | | Effective |
|---|---|---|---|---|
| Poly- | | | | ingredient |
| merized | | | Tg | concent- |
| Resin | Monomer | Dispersant | (° C.) | ration (%) |
| 1 | Methyl | PVA (Polymerization | 5 | 44 |
| | methacrylate + | degree: 1,700, | | |
| | Butyl acrylate | saponification degree: | | |
| | | 88.5%) | | |
| 2 | Methyl | PVA (Polymerization | 5 | 44 |
| | methacrylate + | degree: 500, | | |
| | Butyl acrylate | saponification degree: | | |
| | | 88.5%) | | |
| 3 | Methyl | PVA (Polymerization | −10 | 44 |
| | methacrylate + | degree: 1,700, | | |
| | 2-ethylhexyl | saponification degree: | | |
| | acrylate | 88.5%) | | |
| 4 | Methyl | PVA (Polymerization | 15 | 44 |
| | methacrylate + | degree: 1,700, | | |
| | Butyl acrylate | saponification degree: | | |
| | | 88.5%) | | |
| 5 | Styrene + | PVA (Polymerization | 0 | 44 |
| | Butadiene | degree: 1,700, | | |
| | | saponification degree: | | |
| | | 98.5%) | | |
| 6 | Styrene + | PVA (Polymerization | 5 | 44 |
| | Vinyl acetate | degree: 500, | | |
| | | saponification degree: | | |
| | | 88.5%) | | |
| 7 | Styrene + | PVA (Polymerization | 5 | 44 |
| | Vinyl acetate | degree: 1,700, | | |
| | | saponification degree: | | |
| | | 88.5%) | | |
| 8 | Methyl | PVA (Polymerization | 30 | 44 |
| | methacrylate + | degree: 1,700, | | |
| | Butyl acrylate | saponification degree: | | |
| | | 88.5%) | | |
| 9 | Styrene + | Sodium | 0 | 44 |
| | Butadiene | alkylbenzenesulfonate | | |
| 10 | Methyl | Sodium | −10 | 44 |
| | methacrylate + | alkylbenzenesulfonate | | |
| | 2-ethylhexyl | | | |
| | acrylate | | | |

Preparation of Porous Substrate

Seventy parts by weight of broad-leaved tree kraft pulp, LBKP, beaten until Canadian standard water filter degree was become 330 ml, 25 parts by weight of broad-leaved tree bleached sulfite pulp, LBSP, beaten until Canadian standard water filter degree was become 280 ml, and 5 parts by weight of coniferous tree kraft pulp, NBKP, beaten until Canadian standard water filter degree was become 280 ml were mixed and treated by a double disk refiner to prepare pulp; the rotation speed of the refiner was controlled so that the weight average fiber length of the pulp was 0.55 mm. To 100 parts by weight of the beaten pulp, 2.0 parts of cationized starch, and 0.4 parts of alkylketenedimer resin, 0.1 parts of anionic polyalkylamide resin and 0.7 parts of polyamide-polyamine-epichlorohydrin as the sizing agents were added and the pH value of the mixture was adjusted to 7.5 by sodium hydroxide. The mixture was treated by a Fourdrinier paper machine to make a paper support having a weight of 170 g and a thickness of 160 μm. The paper support was referred to as Porous Substrate 1.

Preparation of Silica Dispersion 1

To 620 l of purified water, pH of thereof was adjusted to 3.0 by nitric acid, 125 kg of silica produced by a gas phase method REOLOSIL QS-20, manufactured by Tokuyama Co., Ltd., having an average diameter of the primary particles was dispersed with suction at a room temperature by Jet Stream Inductor Mixer TDS, manufactured by Mitamura Riken Co., Ltd. Then 1.5 l of Uvitex NFW liquid, manufactured by Ciba Speciality Chemicals CO., Ltd., was added and dispersed by stirring and the total amount of the dispersion was made up to 694 1 by purified water.

Preparation of Silica Dispersion 2

To 18 l of an aqueous solution containing 1.63 kg of cationic polymer P-13, 2.2 l of ethanol and 1.5 l of n-propanol and having a pH value of 3.0, 69.4 l of Silica Dispersion 1 was added while stirring. Then 7.0 l of an aqueous solution having pH of 7.3 and containing 260 g of boric acid and 230 g of borax was added in about 10 minutes and 1 g of anti-foaming agent SN381, manufactured by San Nopco Limited., was further added.

Thus obtained liquid was dispersed by a high pressure homogenizer manufactured by Sanwa Kogyo Co., Ltd., and the total amount of the liquid was made up to 97 1 by purified water to prepare Silica Dispersion 2.

The silica dispersion was diluted and coated on a transparent support and observed by an electron microscope.

As a result of the observation, the average diameter of the particles was 50 nm.

Preparation of Coating Liquid 1

The following coating liquid was prepared using the above-prepared Silica Dispersion 2.

To 650 ml of Silica Dispersion 2 the following additives were added while stirring at 40° C.

(1) A 10% aqueous solution of polyvinyl alcohol PVA 203, manufactured by Kraray Kogyo Co., Ltd.: 6 ml

(2) A 5% aqueous solution of polyvinyl alcohol PVA 235, manufactured by Kraray Kogyo Co., Ltd.: 190 ml

(3) A 5% aqueous solution of polyvinyl alcohol having an average polymerization degree of 4500 and an average saponification degree of 89.0%, manufactured by Kraray Kogyo Co., Ltd.: 70 ml

(4) A 30% solution of surfactant S-1: 4 ml

(5) A 10% solution of anionic fluorescent whitening agent Uvitex NFW Liquid, manufactured by Ciba Specialty Chemicals Co., Ltd.: 10 ml

The total amount of the liquid was made up to 1,000 ml by purified water. The pH value of the coating liquid was 4.5.

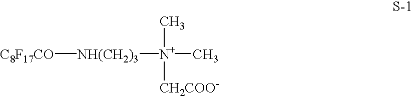

Preparation of Coating Liquid 2

Coating Liquid 2 was prepared in the same manner as in Coating Liquid 1 except that Polymerized Resin 1 shown in Table 1 was added in place of the entire polyvinyl alcohol so that the amount of the effective ingredient of the Polymerized Resin 1 is to be 20.0 g.

Preparation of Recording Paper 101

Coating Liquid 2 and Coating Liquid 1 were simultaneously coated on Porous Substrate 1 so that the wet thickness of each coating liquid was 50 μm and 105 μm, respectively. The coated layers were cooled by 7° C. at once and dried by blowing air with a temperature of from 20° C. to 65° C. to prepare Recording Paper 1. The dried layer thickness of thus prepared porous layer was 38 μm; and the dried amount of the coated solid ingredients was 22 g/m². Preparation of Recording Papers 102 through 110

Recording Papers 102 through 110 were prepared in the same manner as in Recording Paper 101 except that Polymerized Resins 2 through 10 described in Table 1 were used in place of Polymerized Resin 1 as shown in Table 2. Preparation of Recording Papers 111 and 112

Recording Papers 111 and 112 were prepared in the same manner as in Recording Papers 109 and 110 except that Polymerized Resins 9 and 10 were each replaced respectively by previously prepared mixtures of Polymerized Resin 9 or 10 and 22 g of 5% solution of polyvinyl alcohol with a polymerization degree of 1,700 and a saponification degree of 88.5%. The mixtures were each added to Silica Dispersion 2 to prepare the coating liquid. The mixtures were each coated to prepare Recording Papers 111 and 112 , respectively. Preparation of Recording Paper 113

Recording Paper 113 was prepared in the same manner as in Recording Paper 101 except that the foregoing Coating Liquid 1 was coated on the porous substrate 1 so that the wet thickness of coated layer was made to 155 μm. Preparation of Recording Paper 114

Recording Paper 114 was prepared in the same manner as in Recording Paper 101 except that colloidal silica Snowtex XL, manufactured by Nissan Kagaku Co., Ltd., was coated in place of Coating Liquid 2 so that the dry thickness of the coated layer is 20 μm.

Preparation of Recording Paper 115

Recording Paper 115 was prepared in the same manner as in Recording Paper 114 except that colloidal silica combined particle acryl resin emulsion Mowilith 8020, manufactured by Clariant Polymers K.K., was coated in place of the colloidal silica.

Recording Papers 101 through 115 were subjected to the following evaluations. Results of the evaluation are shown in Table 2.

Ink absorption ability

A solid green image was printed on each of the recording papers by ink-jet printer PM 800C, manufactured by Seiko Epson Co., Ltd. Printed image was rubbed by finger just after the printing and the deformation of the image was visually evaluated according to the following 5 ranks.

A: No deformation of the image by the rubbing was occurred.

B: Slight deformation of the image was occurred by the rubbing.

C: The image was deformed a little by the rubbing but the image is acceptable for practical use.

D: The image was considerably deformed by the rubbing; not acceptable for practical used.

E: The ink was remarkably overflowed and the image deformed at the time of printing; not acceptable for practical use.

Smoothness

The center-line surface roughness Ra of the surface of the recording paper before printing was measured according to the method defined by JIS B 0601. The measurement was carried out under the condition of the reference length of 2.5 mm and the cut-off value of 0.8 mm. The results are evaluated according to the following norm.

A: The center-line surface roughness Ra was not more than 0.8 μm; Excellent smoothness was obtained.

B: The center-line surface roughness Ra was within the range of more than 0.8 to 1.2 μm; Good smoothness was obtained.

C: The center-line surface roughness Ra was within the range of more than 1.2 to 1.5 μm; There is little or no problem for practical use, however the smoothness was slightly poor.

D: The center-line surface roughness Ra was larger than 1.5 μm; The smoothness was poor, and there was a problem for practical use.

Maximum Density

Solid images of yellow, magenta and cyan were printed by ink-jet printer PM 800C, manufactured by Seiko Epson Co., Ltd., and the reflective densities of the printed images were each measured by blue, green and red monochromatic light, respectively.

Image Quality

The influence of the ink absorption speed on the image quality was evaluated by visual observation of the printed surface of the recording paper. The result of the observation was ranked according to the following norm.

A: Unevenness of the image quality was not occurred.

B: Inconspicuous unevenness was occurred.

C: The appearance of the image was spoiled by occurrence of unevenness of the image.

Anti-Ink Spreading Ability

A black K fine line with a width of about 200 μm was printed to the recording paper to be evaluated by ink-jet printer PM 770C and the printed paper was stood for 5 days at a temperature of 40° C. and a relative humidity of 80%. The spread of the fine was observed before and after the standing and ranked according to the following norm.

A: The fine line was not spread; the appearance was not spoiled

B: The fine line was slightly spread; the appearance was not spoiled.

C:The fine line was spread; the appearance was spoiled

Results of the evaluation are shown in Table 2

TABLE 2

| | | Ink | | | | | | Anti-ink |
|---|---|---|---|---|---|---|---|---|
| Recording | Binder of lower | absorption | Smooth- | Maximum density | | | Image | spreading |
| paper | layer | ability | ness | Y | M | C | quality | ability |
| 101 (Inv.) | Emulsified | A | B | 1.72 | 2.00 | 2.10 | A | A |
| | Resin 1 | | | | | | | |
| 102 (Inv.) | Emulsified | A | B | 1.71 | 1.99 | 2.09 | A | A |
| | Resin 2 | | | | | | | |
| 103 (Inv.) | Emulsified | A | B | 1.70 | 2.01 | 2.07 | A | A |
| | Resin 3 | | | | | | | |
| 104 (Inv.) | Emulsified | A | B | 1.73 | 2.02 | 2.10 | A | A |
| | Resin 4 | | | | | | | |
| 105 (Inv.) | Emulsified | A | B | 1.72 | 2.00 | 2.08 | A | A |
| | Resin 5 | | | | | | | |
| 106 (Inv.) | Emulsified | A | B | 1.76 | 2.03 | 2.14 | A | A |
| | Resin 6 | | | | | | | |
| 107 (Inv.) | Emulsified | A | B | 1.78 | 2.04 | 2.13 | A | A |
| | Resin 7 | | | | | | | |
| 108 (Inv.) | Emulsified | B | C | 1.70 | 2.01 | 2.08 | A | A |
| | Resin 8 | | | | | | | |
| 109 (Comp.) | Emulsified | C | D | 1.64 | 1.86 | 1.96 | B | A |
| | Resin 9 | | | | | | | |
| 110 (Comp.) | Emulsified | D | C | 1.62 | 1.84 | 1.98 | C | B |
| | Resin 10 | | | | | | | |
| 111 (Comp.) | Emulsified | D | B | 1.57 | 1.82 | 1.92 | C | C |
| | Resin 9 + PVA | | | | | | | |
| 112 (Comp.) | Emulsified | D | B | 1.55 | 1.80 | 1.93 | C | C |
| | Resin 10 + PVA | | | | | | | |
| 113 (Comp.) | PVA | D | C | 1.61 | 1.93 | 1.95 | C | B |
| 114 (Comp.) | — | C | D | 1.61 | 1.82 | 1.95 | C | A |
| 115 (Comp.) | — | C | B | 1.57 | 1.84 | 1.97 | C | B |

(Inv.): (Inventive), (Comp.): (Comparative)

The results of Table 2 shows that Recording Paper 113 using the porous substrate as the support and polyvinyl alcohol only as the binder in all the layers is insufficient in the ink absorption ability and in the image quality since unevenness is occurred in the image printed on this recording paper.

The Recording Papers 109 and 110 without the invention each using the Polymerized resins 9 and 10, respectively, are not suitable since the ink absorption ability and the smoothness are incompatible in these recording papers. In Recording Papers 111 and 112 , in which polyvinyl alcohol is additionally added to the layer containing Polymerized Resins 9 or 10, the ink absorption ability is further degraded and the image quality is also not suitable even though the smoothness is improved. Consequently, it is confirmed that the effect of the invention cannot be obtained only by additionally adding polyvinyl alcohol to the polymerized resin using the surfactant only as the dispersant.

In the comparative Recording Paper 114 having the layer of colloidal silica which is self-crosslink able particle, the smoothness is degraded since cracks are occurred on the surface of the coated layer of the recording paper and the image quality is also not suitable. In Recording Paper 115 having the layer of colloidal silica combined emulsion, the ink absorption ability is insufficient and the image quality is not suitable since the unevenness of the printed image is occurred even though the smoothness is sufficient.

It is understood that Recording Papers 101 through 109 according to the invention are excellent in the ink absorption ability and the smoothness, the maximum density and the image quality are also satisfactory. Particularly, as to the maximum density, the clear image having the high maximum density can be obtained. It is further understood from the competition of Recording Papers 101 through 107 to Recording Paper 108 that the glass transition point of the polymerized resin according to the invention is preferably not more than 20° C. from the viewpoint of the smoothness and the ink absorption ability.

### EXAMPLE 2

Preparation of Recording Paper 201

Recording Paper 201 was prepared in the same manner as in Recording Paper 101 except that silica produced by the wet method FINESIL X-37 with an average particle diameter of 2.7 μm, manufactured by Tokuyama Co., Ltd., was used in place of silica produced by the gas phase method REOLOSIL SQ-20.

Preparation of Recording Paper 202

Coating Liquid 3 was prepared in the same manner as in Coating Liquid 1 except that Polymerized Resin 7 was added so that the effective ingredient was to be 2.7 g in place of 15% of the solid ingredient of the all the polyvinyl alcohol.

Then Recording Paper 202 was prepared in the same manner as in Recording Paper 107 except that Coating Liquid 3 was used in place of Coating Liquid 1.

The recording papers were subjected to the evaluation in the same manner as in Example 1 and the evaluation of crack occurrence caused by the conveying of the recording paper. Results of the evaluation are shown in Table 3. Crack caused by conveying

The recording paper to be evaluated was stored for 3 days at a temperature of 23° C. and a relative humidity of 20%. Then an image is printed on the recording.paper by ink-jet printer PM 770C, manufactured by Seiko Epson Co., Ltd. Thereafter, the situation of the not printed area of the recording surface was visually evaluated and ranked according to the following norm.

A: No crack was occurred.

B: Inconspicuous cracks were occurred on the recording surface.

C: Cracks were occurred on the recording surface so as topsoil the appearance of the surface.

TABLE 3

| | Ink | | | | | | Anti- | |
|---|---|---|---|---|---|---|---|---|
| | absorp- | | Maximum | | | | ink | Cracks |
| Recording | tion | Smooth- | density | | | Image | spread- | caused by |
| paper | ability | ness | Y | M | C | quality | ing | conveying |
| 107 (Inv.) | A | A | 1.78 | 2.04 | 2.13 | B | A | B |
| 201 (Comp.) | C | C | 1.51 | 1.79 | 1.93 | D | B | C |
| 202 (Inv.) | A | A | 1.74 | 2.00 | 2.08 | B | A | A |

(Inv.): (Inventive), (Comp.): (Comparative)

As is shown in Table 3, in Recording Paper 201 in which the average diameter of the inorganic particle contained in the ink-receiving layer exceeds 200 nm, the image quality is unsuitable since the ink absorption ability is degraded; and the smoothness and the density are also lowered. Moreover, the racks are occurred in the course of the conveying of the paper so as to be unsuitable for practical used.

Besides, it is understood that Recording Paper 202 according to the invention which has the upper ink-receiving layer comprising Polymerized Resin 7 emulsified-polymerized by the polymer dispersant and polyvinyl alcohol as the binder is preferable compared with the Recording Paper 107 since the softness of the ink-receiving layer is raised by the polymerized resin according to the invention and the crack occurrence by the conveying of the paper after the storage at the low temperature is improved in Recording Paper 202.

### EXAMPLE 3

Preparation of Recording Paper 301

Coating Liquid 4 was prepared in the same manner as in Coating Liquid 1 of Example 1 except that 93% of the solid ingredient in each of the 5% aqueous solution of polyvinyl alcohol PVA 235 and the 5% aqueous solution of the polyvinyl alcohol having an average polymerization degree of 4500 and an average saponification degree of 89.0% was replaced by Polymerized Resin 7 so that amount of the effective ingredients was to be 20.0 g.

Recording Paper 301 was prepared in the same manner as in Recording Paper 107 except that Coating Liquid 4 was used in place of Coating Liquid 2.

Preparation of Recording Paper 302

Coating Liquid 5 was prepared in the same manner as in Coating Liquid 1 of Example 1 except that 80% of the solid ingredient in each of the 5% aqueous solution of polyvinyl alcohol PVA 235 and the 5% aqueous solution of polyvinyl alcohol having an average polymerization degree of 4500 and an average saponification degree of 89.0% was replaced by Polymerized Resin 7 so that amount of the effective ingredients was to be 20.0 g.

Recording Paper 302 was prepared in the same manner as in Recording Paper 107 except that Coating Liquid 5 was used in place of Coating Liquid 2.

Thus obtained samples were evaluated in the same manner as in Example 2. Results of the evaluation are shown in Table 4.

TABLE 4

| | Ink | | | | | | Anti- | |
|---|---|---|---|---|---|---|---|---|
| | absorp- | | Maximum | | | | ink | Cracks |
| Record- | tion | Smooth- | density | | | Image | spread- | caused by |
| ing paper | ability | ness | Y | M | C | quality | ing | conveying |
| 107 (Inv.) | A | A | 1.78 | 2.04 | 2.13 | A | A | B |
| 301 (Inv.) | A | A | 1.79 | 2.06 | 2.12 | A | A | B |
| 302 (Inv.) | B | A | 1.79 | 2.04 | 2.13 | B | B | B |

(Inv.): (Inventive), (Comp.): (Comparative)

It is cleared by the comparison of Recording Papers 107, 301 and 302 that the effects of the invention can be obtained even when the polyvinyl alcohol as the water-soluble polymer is used in the layer containing the polymerized resin according to the invention.

### EXAMPLE 4

Preparation of Polymerized Resins 11 and 12 Polymerized Redins 11 and 12 shown in following Table 5 were prepared by a method similar to the preparing method for polymerized resin in Example 1, except for that the polyvinyl alcohol in the aqueous solution, which was used during the emulsion polymerization, was changed to the polyvinyl alcohol having an average polymerization degree of 3500 and an average saponification degree of 88.5%. Polymerized Resin 1 and 2 were used in order to compare with Polymerized Resin 11 and 12.

The obtained Polymerized Resin were diluted by water, and the diameter of each of Polymerized Resin was measured. The average diameter of each of Polymerized Resins was 0.3 μm.

TABALE 5

| | | | | Effective |
|---|---|---|---|---|
| Poly- | | | | ingredient |
| merized | | | Tg | concent- |
| Resin | Monomer | Dispersant | (° C.) | ration (%) |
| 1 | Methyl | PVA (Polymerization | 5 | 44 |
| | methacrylate + | degree: 1,700, | | |
| | Butyl acrylate | saponification degree: | | |
| | | 88.5%) | | |
| 2 | Methyl | PVA (Polymerization | 5 | 44 |
| | methacrylate + | degree: 500, | | |
| | Butyl acrylate | saponification degree: | | |
| | | 88.5%) | | |
| 11 | Methyl | PVA (Polymerization | 0 | 44 |
| | methacrylate + | degree: 3,500, | | |
| | Butyl acrylate | saponification degree: | | |
| | | 88.5%) | | |
| 12 | Methyl | PVA (Polymerization | −30 | 44 |
| | methacrylate + | degree: 3,500, | | |
| | Butyl acrylate | saponification degree: | | |
| | | 88.5%) | | |

Preparation of Silica Dispersion 3

To 18 l of an aqueous solution containing 1.63 kg of cationic polymer P-9, 2.2 1 of ethanol and 1.5 1 of n-propanol and having a pH value of 3.0, 69.4 l of Silica Dispersion 1 was added while stirring. Then 7.0 l of an aqueous solution containing 275 g of boric acid and 165 g of borax was added and 1 g of anti-foaming agent SN381, manufactured by San Nopco Limited., was further added.

Thus obtained liquid was dispersed by a high pressure homogenizer manufactured by Sanwa Kogyo Co., Ltd., and the total amount of the liquid was made up to 97 1 by purified water to prepare Silica Dispersion 3.

The silica dispersion was diluted and coated on a transparent support and observed by an electron microscope. As a result of the observation, the average diameter of the particles (secondary particles) was 50 nm.

Preparation of Coating Liquid 6

The following coating liquid was prepared using the above-prepared Silica Dispersion 3.

To 650 ml of Silica Dispersion 2 the following additives were added while stirring at 40° C.

(1) A 10% aqueous solution of polyvinyl alcohol PVA

203, manufactured by Kraray Kogyo Co., Ltd.: 6 ml

(2) A 5% aqueous solution of polyvinyl alcohol PVA 235, manufactured by Kraray Kogyo Co., Ltd.: 260 ml

(3) A 5% aqueous solution of polyvinyl alcohol having an average polymerization degree of 4500 and an average saponification degree of 89.0%: 95 ml

(4) A (5) A 10% solution of anionic fluorescent whitening agent Uvitex NFW Liquid, manufactured by Ciba Specialty Chemicals Co., Ltd.: 10 ml 30% solution of surfactant S-1: 4 ml

The total amount of the liquid was made up to 1,000 ml by purified water. The pH value of the coating liquid was 4.5.

Preparation of Recording Papers 401 to 403

Recording Papers 401 to 403 were prepared in the manner similar to the preparing method of Recording Paper 107 except that Polymerized Resins are were changed as shown in following Table 6, and Coating Liquid 6 was used instead of Coating Liquid 2.

The Recording Papers 401 to 403 were subjected to the evaluation in the same manner as in Example 1. Results of the evaluation are shown in Table 6.

TABLE 6

| | | | | | | | | Anti- |
|---|---|---|---|---|---|---|---|---|
| | | | | | | | | ink |
| | Binder of | absorp- | | Maximum | | | | spread- |
| Recording | lower | tion | Smooth- | density | | | Image | ing |
| paper | layer | ability | ness | Y | M | C | quality | ability |
| 101 (Inv.) | Emulsified | A | A | 1.72 | 2.00 | 2.10 | A | A |
| | Resin 1 | | | | | | | |
| 102 (Inv.) | Emulsified | A | A | 1.71 | 1.99 | 2.09 | A | A |
| | Resin 2 | | | | | | | |
| 103 (Inv.) | Emulsified | A | A | 1.70 | 2.01 | 2.07 | A | A |
| | Resin 3 | | | | | | | |
| 104 (Inv.) | Emulsified | A | A | 1.73 | 2.02 | 2.10 | A | A |
| | Resin 4 | | | | | | | |
| 105 (Inv.) | Emulsified | A | A | 1.72 | 2.00 | 2.08 | A | A |
| | Resin 5 | | | | | | | |
| 106 (Inv.) | Emulsified | A | A | 1.76 | 2.03 | 2.14 | A | A |
| | Resin 6 | | | | | | | |
| 107 (Inv.) | Emulsified | A | A | 1.78 | 2.04 | 2.13 | A | A |
| | Resin 7 | | | | | | | |

By comparing the inventive Recording Papers 101, 102, and 401 to 404, it was shown that Recording Papers 402 to 404, in which, as the polymer dispersant having a hydroxyl group, polyvinyl alcohol having relatively high polymerization degree were used for the emulsion polymerization and the polymerized resins having particle diameter in the preferable range of the invention were used, were relatively excellent in smoothness. Specifically, it was shown that Recording Papers 403 and 404, in which, as the polymer dispersant having a hydroxyl group, polyvinyl alcohol having relatively high polymerization degree were used for emulsion polymerization and, in the ink-receiving layer, cationic polymer having a monomer unit represented by General Formula (1) was used, were specifically excellent in smoothness and Maximum density.

As above-mentioned, the ink-jet recording material can be obtained by the invention, which is excellent in the ink absorption ability and anti-cockling ability, and gives a suitable maximum density and a high image quality.

### Effects of the Invention

The ink-jet recording material can be provided by the invention, which has the suitable ink absorption ability and the image density and excellent ant-ink spread ability and resistively to crack by conveying and gives the high quality image for a print with the photographic quality.

What is claimed is:

1. An ink-jet recording material comprising a support having thereon a first layer and an ink-receiving layer in that order,
wherein the first layer comprising a resin polymerized by emulsion polymerization in the presence of a polymer dispersant having at least a hydroxyl group; and
the ink-receiving layer comprising a water-soluble binder and inorganic particles having an average particle diameter of 3 to 200 nm.

2. The ink-jet recording material of claim 1, wherein the support is a porous substrate.

3. The ink-jet recording material of claim 1, wherein the first layer comprises inorganic particles.

4. The ink-jet recording material of claim 3, wherein the ink-receiving layer comprises a resin polymerized by emulsion polymerization in the presence of a polymer dispersant having at least a hydroxyl group.

5. The ink-jet recording material of claim 4, wherein the weight ratio of the inorganic particles to the polymerized resin (the weight of the inorganic particles/the weight of the polymerized resin) in the first layer is within the range of 2 to 10, and the weight ratio of the inorganic particles to the polymerized resin (the weight of the inorganic particles/the weight of the polymerized resin) in the ink-receiving layer is not less than 15.

6. The ink-jet recording material of claim 1, wherein the polymer dispersant is a polyvinyl alcohol.

7. The ink-jet recording material of claim 6, wherein the average polymerization degree of the polyvinyl alcohol is within the range of 1500 to 5000.

8. The ink-jet recording material of claim 1, wherein the emulsified resin has a glass-transition temperature of not more than 20° C.

9. The ink-jet recording material of claim 1, wherein the inorganic particle is silica obtained by a gas phase method.

10. The ink-jet recording material of claim 1, wherein the water-soluble binder is a polyvinyl alcohol.

11. The ink-jet recording material of claim 10, wherein the weight ratio of the inorganic particles to the polyvinyl alcohol (the weight of the inorganic particles/the weight of the polyvinyl alcohol) in the ink-receiving layer is within the range of 3 to 20.

12. The ink-jet recording material of claim 1, wherein at least one of the ink-receiving layer and the first layer is hardened with a hardening agent.

13. The ink-jet recording material of claim 1, wherein at least one of the ink-receiving layer and the first layer comprises a cationic compound.

14. The ink-jet recording material of claim 13, wherein the cationic compound is a polymer including a monomer unit represented by the following General Formula (1),
General Formula (1) 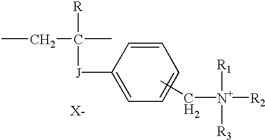
wherein R represents a hydrogen atom or an alkyl group; each of R₁, R₂ and R₃ represents an alkyl group or benzyl group, independently; J represents a single bond or a divalent organic group; and X⁻ represents an anion group.
